(19) United States
(12) Patent Application Publication
(10) Pub. No.: US 2010/0053069 A1
(43) Pub. Date: Mar. 4, 2010

(54) MOBILE COMPUTING SYSTEM FACILITATING ADAPTIVE DISPLAY OF CONTENT AMONG A PLURALITY OF DISPLAY COMPONENTS INCLUDING AT LEAST ONE VIRTUAL IMAGE DISPLAY COMPONENT

(75) Inventors: Nicole D. Tricoukes, Seaford, NY (US); Patrick Riechel, Briarwood, NY (US); Tom Roslak, Northport, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/198,844

(22) Filed: Aug. 26, 2008

(51) Int. Cl. G09G 5/00

(52) U.S. Cl. 345/156; 345/1.3; 345/7

(57) ABSTRACT

Systems, devices, and/or methods that facilitate adaptive display of content among a plurality of display components including at least one virtual image display component are presented. The disclosed subject matter facilitates forming determinations or inferences based on various metrics for adaptively routing content to select display devices. The display interface component, at least in part, routes content selectively between a primary display component and a virtual image display (VID) component. This can better optimize the use of VID components to avoid overstimulation of a user while allowing access to the benefits of the VID component under predetermined conditions.

### TECHNICAL FIELD

The subject innovation relates generally to mobile computing devices, methods, and/or systems and more particularly to these devices, methods, and/or systems facilitating adaptive display of content among a plurality of display components, the plurality including at least one virtual image display component.

### BACKGROUND

Traditionally, virtual image display (VID) devices, systems, and methods are employed as substitute primary displays. These VID systems typically employ optical imaging techniques to facilitate the design of an optical component that creates a virtual image observable by a user. Thus, the illumination on a very small display screen (e.g., a real image) is typically observed by a user as a much larger image (e.g., the virtual image). For example, heads up displays in a fighter-jet cockpit can create a virtual image superimposed over the actual horizon wherein the virtual image can impart information such as air speed, altitude, and attitude. Further, this information can appear larger to the pilot than the real image on the surface of the heads up display component.

Another increasingly familiar virtual image system can include wearable computer device displays. Where it would be impractical to strap a full 14-inch display to an armature in front of the user as the user goes about their daily life, virtual image devices provide an elegant solution. The VID can provide a very small real image, perhaps mere millimeters in total surface area, which appears to the user as a virtual image of a full size video monitor. Where these devices provide mobility and usability, they are becoming increasingly popular in certain applications (e.g., advanced military weapons platforms, virtual reality systems, . . . )

Where the VID offers advantages such as small size and reduced power consumption over conventional display systems and are clearly highly practical in mobile computing environments, the VID image system is typically employed as the user interface for said mobile computing devices. For example, in a wearable computer with a VID disposed proximal to the user's eye, the user will interact with the mobile computing system directly through the VID image (e.g., it can be such that the VID image is a floating computer display observable by the user). These systems typically do not employ other display devices for user interaction because the VID device can generally create any sized virtual image needed for communicating information to a user of such a system.

Some applications can benefit from having a VID device as a means of displaying certain information to a user and interacting with a user while still providing other information through a more traditional mobile device display. As an example, a delivery driver may generally be able to function efficiently with information presented on a mobile device LCD screen as they deliver packages in rural neighborhood. However, there can be situations where a larger image would be helpful to the delivery person in this example. One such situation can be that the driver is delivering to an unfamiliar neighborhood and a map would be useful in finding the correct delivery location. In this instance, a VID can present the driver with supplementary information (e.g., the map) in a larger virtual image format that can arguably be more useful than a similar map on the typically smaller mobile device display. Numerous other examples can be presented in which a VID device is not used as the primary display for a mobile computing device. In these examples the VID device can be used for accessing supplementary information relevant to the user experience within the mobile computing environment. This allows for more frugal use of the VID device, and simultaneous use of the primary information on a standard mobile display in addition to the supplementary information presented through a VID display.

### SUMMARY

The following presents a simplified summary of the subject innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventionally, mobile computing devices, systems, and methods employ traditional display devices that are relatively small scale to facilitate being mobile. Typical examples are personal digital assistant (PDA) screens, Smartphone screens, Global Positioning Satellite (GPS) receiver screens, and the like. Increasingly, virtual image display (VID) devices and systems are providing mobile computing devices with relatively smaller displays and/or image forming optics (e.g., millimeter sized surface area LCD displays, head-mounted monocular/binocular heads-up displays, retinal projectors, . . . ) that present a user with a virtual image of a much larger display. These imagers can present the image as opaque (e.g., a floating display screen) or superimposed (e.g., the real world is visible through he floating image presented to the user). VID systems conventionally represent the primary or only display of information made available for the user to interact with the mobile computing system. Generally stated, the VID system is a substitute for a traditional computer monitor in mobile computing systems.

While a VID system can be extremely useful for users of a mobile computing system as the primary display, there are numerous application in which the VID can be better employed for presenting additional information suited to display on a larger virtual display while still presenting primary information on a traditional mobile device display (e.g., a smaller LCD display). Generally, a “floating display screen” can be a hindrance or irritant to users of a mobile computing system where the same information can be effectively communicated through a more traditional display that would avoid the persistent “floating screen”. Where the VID may be of benefit for certain types of user interactions with the mobile computing system and the conventional display can be beneficial for other types of interaction, effectively routing appropriate information between a conventional display and a VID display can present additional benefit to mobile computing device users.

In accordance with one aspect of the disclosed subject matter, a mobile computing system facilitating adaptive display of content among a plurality of display components including at least one virtual image display component is presented. This system can comprise a plurality of display devices, the plurality including at least one VID device. Further, such a system can comprise a display interface component to facilitate routing information selectively and adaptively among the plurality of displays. Generally, where information is suited for conventional mobile computing device displays, content can be routed to a conventional display (e.g., a relatively smaller LCD display, electronic paper display, projected display . . . ). However, where operating conditions or the nature of the content indicate that a virtual image would be beneficial (e.g., a larger image can provide better detail, a virtual image can be useful while performing tasks that limit the use of the user's hands, . . . ) content can be routed to the VID.

In accordance with another aspect of the disclosed subject matter, the routing of content among the plurality of display devices generally is exclusive, meaning that information or content routed to a first display is generally different content than routed to a second display (e.g., the second display is not displaying the same content as the first display, the second display content is therefore generally exclusive of the first display content.)

In accordance with another aspect of the subject innovation, the content can be interacted with through the mobile computing system or through an interface of the VID system in a separate manner. For example, where a customs officer calls up a supplementary HAZMAT information sheet in a VID image to supplement shipping information simultaneously presented on a conventional display, the VID image can be scrolled by, for example, voice command directly through the VID system components without burdening the mobile computing system. Similarly, where a medical application presents a nurse with a VID virtual medical history of a patient to supplement current vital statistics being presented on a conventional display, the nurse can update the medical history by interacting with the mobile computing system to cause the current vital statistics to be uploaded into the patient's medical history.

In accordance with another aspect of the subject innovation, the routing of content can benefit from access to an information network in addition to the information stored locally. For example, where a mobile computing system is employed in warehousing, primary information can include pallet pick times and processing line numbers based on, for example, RFID's or bar codes for boxes that are stored locally, and supplementary information can for example include package content information or emergency spill response information also stored locally. However, in another similar example, where a wired and/or wireless network is available (e.g., an intranet, extranet, or the internet) primary or supplementary information can be related to updated information that is refreshed over the network. Thus, in this example, the primary information can indicate a product to pick at a particular time based on a just in time delivery model, or similarly, supplementary information can include real time process line conditions to facilitate a warehouse worker more efficiently coordinating product picks across a plurality of lines.

In accordance with another aspect of the subject innovation, the system can include various user interface modalities for interacting with content displayed as routed among the plurality of display components. For example, user interfaces can include touch sensitive displays, stylus modalities, voice/audio control, keyboards, mice, chording devices, touch pads, and the like for interacting with either a conventional or VID display. One of skill in the art will appreciate that numerous other interaction modalities and all such combinations of those listed and not listed are feasible and germane to the disclosed subject matter and as such are within the scope of said disclosure. Thus, for example, a conventional display on a PDA can be a touch sensitive LCD for presenting primary content to a user while a VID component can be separately voice controlled and simultaneously interacted with through the touch LCD display of the mobile computing device while displaying supplementary information to a user.

In accordance with other aspects of the subject innovation, mobile computing systems employing content routing can also employ other real world interaction components and sensors. For example, RFID tags can be read by an RFID reader that is part of the VID system, mobile computing device, distributed computing environment, or combinations thereof. This RFID information can facilitate routing particular content to the mobile device displays in a selective manner. One of skill in the art will appreciate that nearly a limitless number of sensors or interaction components can be employed within the scope of the disclosed subject matter. As a particular example, where a bar code scanner reads a bar code from a box containing a caustic chemical as it is loaded into a delivery truck, such information can be passed through the network to a network attached mobile computing system used by the driver, whereon the primary display can present a delivery address and contact info for the chemical package and the supplementary VID can present precautions for handling the chemical, the location of the package in the load on the truck, and the contacts for emergency conditions as such information is determined to be relevant for routing to the VID device.

To the accomplishment of the foregoing and related ends, the innovation, then, comprises the features hereinafter fully described and particularly pointed out in the claims. The following description and the annexed drawings set forth in detail certain illustrative embodiments of the innovation. These embodiments can be indicative, however, of but a few of the various ways in which the principles of the innovation can be employed. Other objects, advantages, and novel features of the innovation will become apparent from the following detailed description of the innovation when considered in conjunction with the drawings.

### BRIEF DESCRIPTION OF THE DRAWINGS

FIG. 1 is a diagram of a system that can facilitate adaptive display of content among a plurality of display components including at least one virtual image display component in accordance with an aspect of the subject matter disclosed herein.

FIG. 2 is a diagram of a system that can facilitate adaptive display of content among a plurality of display components including at least one virtual image display component in accordance with an aspect of the subject matter disclosed herein.

FIG. 3 is a diagram of a system that can facilitate adaptive display of content among a plurality of display components including at least one virtual image display component in accordance with an aspect of the subject matter disclosed herein.

FIG. 4 is a diagram of a possible exemplary system that can facilitate adaptive display of content among a plurality of display components including at least one virtual image display component in accordance with an aspect of the subject matter disclosed herein.

FIG. 5 is a diagram of a possible exemplary system that can facilitate adaptive display of content among a plurality of display components including at least one virtual image display component in accordance with an aspect of the subject matter disclosed herein.

FIG. 6 illustrates a methodology that can facilitate adaptive display of content among a plurality of display components including at least one virtual image display component in accordance with an aspect of the subject matter disclosed herein.

FIG. 7 illustrates a methodology that can facilitate adaptive display of content among a plurality of display components including at least one virtual image display component in accordance with an aspect of the subject matter disclosed herein.

FIG. 8 illustrates a methodology that can facilitate adaptive display of content among a plurality of display components including at least one virtual image display component in accordance with an aspect of the subject matter disclosed herein.

FIG. 9 illustrates a possible exemplary methodology that can facilitate adaptive display of content among a plurality of display components including at least one virtual image display component in accordance with an aspect of the subject matter disclosed herein.

FIG. 10 illustrates a block diagram of an exemplary electronic device in accordance with an aspect of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It is evident, however, that the disclosed subject matter can be practiced without these specific details. In other instances, well-known structures and devices are shown in block diagram form in order to facilitate describing the subject innovation.

Traditional mobile computing systems can employ virtual image display (VID) devices, systems, and methods as substitute primary displays. These VID systems typically employ optical imaging techniques to facilitate the design of an optical component that creates a virtual image observable by a user. The image observed by the user in these systems is a virtual image that is frequently many times larger than the real image in the optical component. Where these systems are employed, they frequently are substitutes for traditional mobile computing device displays such as LCD screens, projection displays, and the like. Where VID systems are employed the space and weight savings combined with improved mobility can reinforce use of the VID display as the primary and frequently only visual user interface for a mobile computing system. This can be observed in military equipment where the VID serves as a primary interface for a weapons system for example. Similarly, in many wearable computer systems, the user interacts with the computing system visually through only the VID device.

In contrast to these conventional systems, a VID can be employed to provide information to a user more selectively. This selective use of a VID system in conjunction with other display components can be termed as adaptive display of content. By adapting the displayed content to distinct display devices, the user can rapidly interact with a mobile computing device without always shifting attention to a primary virtual display. This allows the user to selectively employ a VID and reduces the need to interfere with the user's normal visual horizon except where supplementary information or content preferably displayed on a VID is desired.

In accordance with one aspect of the disclosed subject matter, a mobile computing system facilitating adaptive display of content among a plurality of display components including at least one virtual image display component is presented. This system can comprise a plurality of display devices, the plurality including at least one VID device. Further, such a system can comprise a display interface component to facilitate routing information selectively and adaptively among the plurality of displays. Generally, where information is suited for conventional mobile computing device displays, content can be routed to a conventional display (e.g., a relatively smaller LCD display, electronic paper display, projected display . . . ). However, where operating conditions or the nature of the content indicate that a virtual image would be beneficial (e.g., a larger image can provide better detail, a virtual image can be useful while performing tasks that limit the use of the user's hands, . . . ) content can be routed to the VID. In an aspect the information displayed on a first display device is distinct from the content displayed on a second display device (e.g., the second display is not displaying the same content as the first display, the second display content is therefore generally exclusive of the first display content.)

In accordance with another aspect of the subject innovation, the displayed content can be interacted with by the user through the mobile computing system interface and/or through a separate VID system interface. For example, the primary and/or secondary content displays can be interacted with through a keypad connected through the mobile computing device. Similarly, for example, the primary display device can be controlled with a keyboard connected through the mobile computing device and the secondary content display can be interacted with through voice commands processed by the VID system itself (e.g., the VID system can accept direct input, process that input, and communicate that processed input to a processor to interact with content being presented on the VID). Additionally, the secondary content display system can facilitate interaction with the primary and secondary content displayed independent of the mobile computing system. As an example, a PDA with a VID system can display primary content on the PDA and supplementary content on the VID while allowing interaction with both content sets through the PDA, interaction with only the primary content through the PDA while interaction with the supplementary content is through processing done in the VID system, and/or interaction with both the primary and supplementary content can be through the VID system.

Where the VID system facilitates interaction with the content of either the primary or supplementary content, input can be received by the VID system. This information can be processed by the VID system and can facilitate interaction with the content displayed. For example, eye movements can be tracked by the VID system to, for example, pan, zoom, scroll, dial, type, mouse, and/or facilitate any of a nearly limitless number of other content interactions. These interactions can be directed to back to the mobile computing system by the VID system or can directly act on the content being displayed by the VID system. Further, the VID system can communicate these processed interactions back over a network directly to allow interaction with the content without any burden on the mobile computing system at all. In this regard, the VID system begins to approach an independent mobile computing system in the richness of available features in an almost distributed computing sense while still remaining a sub-system for displaying content related to the primary display of the user's mobile computing system.

In accordance with another aspect of the subject innovation, the routing of content can benefit from access to an information network in addition to the information stored locally. Information can be served over a wired and/or wireless network or a distributed computing environment can be enabled by a wired and/or wireless network to facilitate adaptive displaying of content to a user of a mobile computing system. Where the VID system has rich features, the VID system itself can access network resources to obtain content for display. In less rich VID systems, displayed content can be received through the mobile computing system for routing to the designated display devices.

In accordance with another aspect of the subject innovation, the system can include various user interface modalities for interacting with content displayed as routed among the plurality of display components. For example, user interfaces can include touch sensitive displays, stylus modalities, voice/audio control, keyboards, mice, chording devices, touch pads, and the like for interacting with either a conventional or VID display. One of skill in the art will appreciate that numerous other interaction modalities germane to the disclosed subject matter are to be considered within the scope of the disclosed subject matter.

In accordance with other aspects of the subject innovation, mobile computing systems employing adaptive content routing can also employ other real world interaction components and sensors. These additional interfaces can, for example, include RFID, bar codes, visual recognition systems, haptics, biometrics, chemical or physical condition sensors, and the like. One of skill in the art will appreciate that nearly a limitless number of sensors or interaction components can be germane to the disclosed subject matter and as such are to be considered within the scope of the disclosed subject matter.

The subject innovation is hereinafter illustrated with respect to one or more arbitrary architectures for performing the disclosed subject matter. However, it will be appreciated by one of skill in the art that one or more aspects of the subject innovation can be employed in other memory system architectures and is not limited to the examples herein presented.

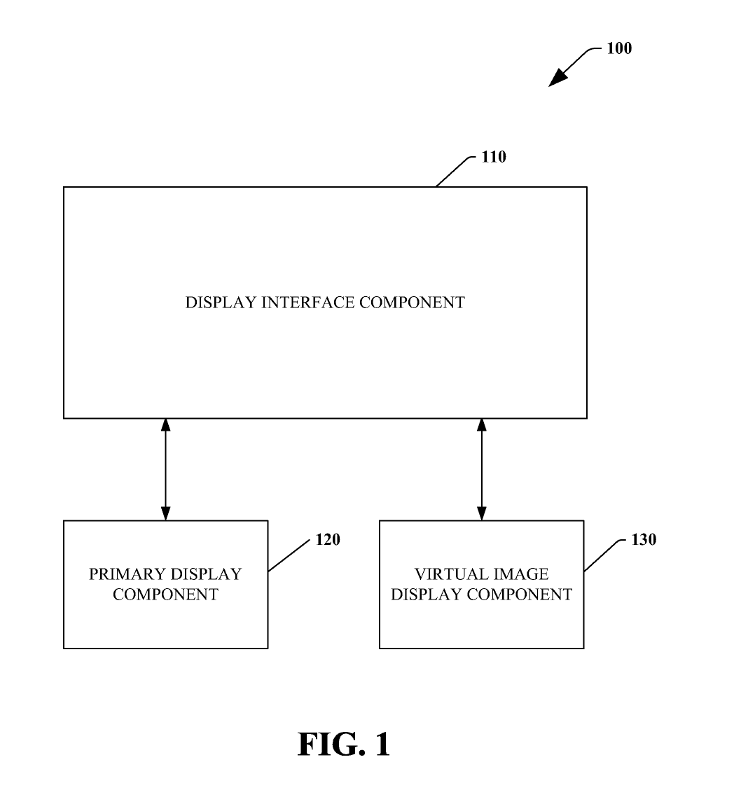

Turning to FIG. 1, illustrated is a diagram of a system 100 that can facilitate adaptive display of content among a plurality of display components including at least one virtual image display component in accordance with an aspect of the subject matter disclosed herein. System 100, for example, can include a display interface component 110.

In an aspect, display interface component 110 can facilitate adaptive routing of content among a plurality of display components including at least one VID display component. Content for display to a user can be received by a mobile computing device. This content can contain content best displayed on typical mobile device displays and/or best displayed on a VID. Based on one or more metrics the content can be routed to a selected display component by the display interface component 110.

In an aspect these metrics can be of varying levels of complexity. For example, the routing can be based on the resolution of the content to be displayed, such that, for example, where the content can be displayed on a 320×480 display it can be routed to the primary display of a PDA and where, for example, it is best displayed at 800×600 it can be routed to a SVGA VID component by the display interface component 110. Other metrics can include, for example, user selected routing of specific content, types of content, or content meeting certain criteria; content flagged for routing to specific display components, content determined or inferred to be appropriate for a specific display component (e.g., inferring that content is primary content can result in routing to a primary display component), among many other metrics. The term inferences as used herein can refer to employing artificial intelligence as described supra. One of skill in the art will appreciate that numerous metrics can be employed in a variety of combinations to achieve highly intelligent and directed routing of content among displays as disclosed in relation to the subject innovation and that all such metrics are considered within the scope of the disclosed subject matter.

Display interface component 110 can further facilitate routing of user interactions with the displayed content. A user interface, for example a mouse, can be communicatively coupled to the display interface component 110. User interactions with content displayed on any of the plurality of display components can be received by the display interface component 110. Further, display interface component 110 can process these interactions to facilitate user interaction with the displayed content.

In another aspect, system 100 can comprise a plurality of display components, including at least one VID component, communicatively coupled to the display interface component 110. Primary display component 120 and Virtual Image Display (VID) component 130 represent the plurality of display components in system 100. Primary display component 120 can be a conventional mobile computing device display component. Primary display component 120 can, for example, be a LCD display in a Smartphone or PDA, a projected display, e-paper, or some other conventional display component as would be appreciated by one of ordinary skill in the art. VID component 130 can be any display component that creates a virtual image viewed by a user, such virtual image typically representing a display that has a larger area or better resolution than a conventional display component (e.g., a virtual image typically will be an image corresponding to a “full sized and full resolution” computer display image such as a 14-, 18-, or 21-inch display).

In system 100, received content can be routed between the primary display component 120 and the VID component 130 by the display interface component 110. This can most easily be illustrated by the following example. Where, for example, the mobile computing system is a grocery store stock ordering mobile device, received content can be related to grocery items being ordered by a store clerk as the clerk walks around the store scanning UPC's for products with low in stock quantities. Continuing this example, as the clerk scans in an item, the content to be displayed can be the product name, minimum order quantities, and lead time for receiving a restocking order. This information can be determined (e.g., by display interface component 110) to be primary content and can be displayed to the clerk directly on the LCD screen (e.g., primary display component 120) of the stock ordering mobile device and by similar determination no additional information need be displayed on the head mounted VID of the grocery clerk.

Continuing the current example, where the clerk scans in the next low stock product, the content received by the display interface component 110 can indicate that two additional cases of the product are located in the stockroom and that an order is not needed. This content can then be routed, for example, by displaying the product name, minimum order quantities, and lead time for receiving a restocking order on the primary display 120 as for the previous product and in addition now routing to the VID display a graphical map of the location of the two cases in the stockroom. This graphical information can be better displayed on the larger virtual image allowing the grocery clerk to more easily locate the items in the stockroom and bring them to the floor to replenish the dwindling supply on the shelf.

Again continuing the current example, the clerk can receive a request for additional product information from a customer. In response the clerk can scan the product bar code and receive the established primary display information (product name, minimum order quantities, and lead time for receiving a restocking order). The clerk can then indicate on the stock ordering mobile device that additional information is needed. The stock ordering mobile device can then route this additional information to the VID component allowing the clerk to select a subset of the detailed information for display on the primary display allowing the customer to view the subset of the detailed information. One of skill in the art will appreciate that this is a very limited example of routing content based on several metric among the plurality of display devices of the presently disclosed subject matter. Further, one of skill in the art will appreciate that this example is given only to illustrate certain aspects of the disclosed subject matter and in not intended to communicate all aspects or features of the disclosed subject matter. Additionally, it will be appreciated that aspects and features not disclosed in the immediately preceding example are still to be considered within the scope of the disclosed subject matter where they are disclosed elsewhere in the present disclosure.

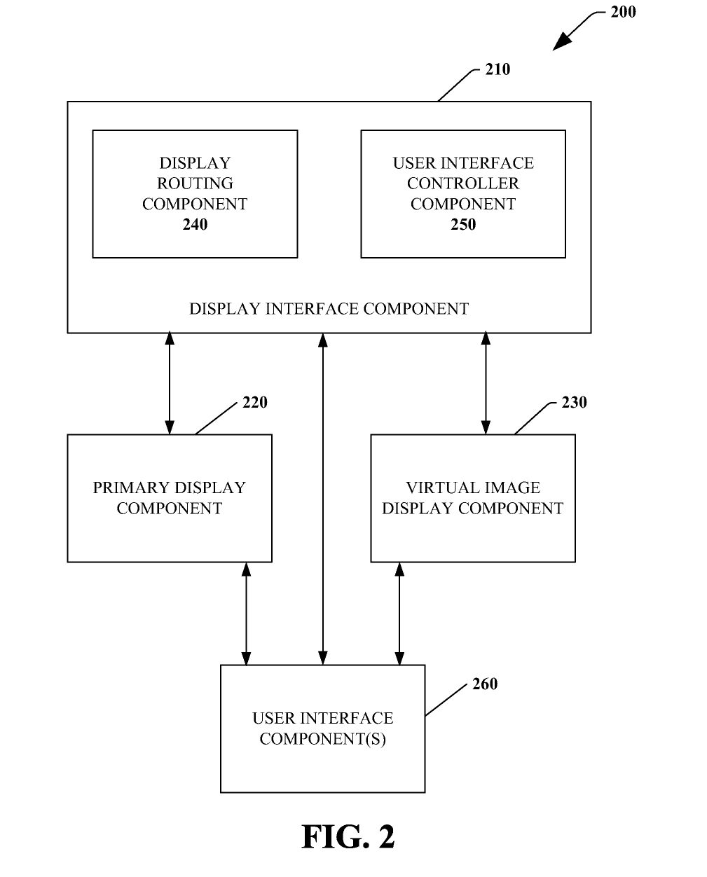

Referring now to FIG. 2, illustrated is a diagram of a system 200 that can facilitate adaptive display of content among a plurality of display components including at least one virtual image display component in accordance with an aspect of the subject matter disclosed herein. System 200, for example, can include a display interface component 210. Display interface component 210 can be the same as, or similar to, display interface component 110. Display interface component 210 can be communicatively coupled to a primary display component 220 and a VID component 230. Primary display component 220 can be the same as, or similar to, primary display component 120 and VID component 230 can be then same as, or similar to, VID component 130. Display interface component 210 can further comprise a display routing component 240 and a user interface component 250.

In an aspect, display routing component 240 can facilitate determining or inferring the routing of content received by the display interface component 210 for routing among the plurality of display components including the primary display component 220 and the VID component 230. The display routing component 240 can employ one or more metrics as disclosed herein to determine or infer proper routing of content. A determination on routing content to a selected display can be based at least in part on measurements of the content traversing a predetermined indicator value. For example, where the metric is related to graphical resolution, the native resolution of the content can be determined and measured against the resolutions of available display devices such that the content is routed to the most appropriate display. Similarly, metrics can be combined to provide more advanced routing, for example, where content is of type “primary” (e.g., type primary would typically be display on a primary display device) the content can be displayed on a VID component where the user context metric indicates that the primary display in use or unavailable (e.g., the user is driving and can't pick up the primary display to view the content). As stated herein, the variety of metrics and complex combinations of metrics to provide advanced dynamic content routing will be appreciated by one of skill in the art and all such combinations and metrics are to be considered within the scope of the disclosed subject matter.

In another aspect, system 200 can include a user interface controller component 250. User interface controller component 250 can facilitate user interface interaction with displayed content as also disclosed elsewhere herein. Where system 200 can include user interface components 260 and these components can allow interaction with displayed content, user interface controller component 250 can route controller interaction among the plurality of display components. User interface controller component 250 can receive user interface input directly from a user interface component 260 connected to the user interface controller component 250 (illustrated as connected by being a sub-component of the display interface component 210) or from a display component (e.g., 220, 230) coupled to a user interface component 260.

For example, where a touch screen primary display component is employed (e.g., a touch sensitive display is both a user interface component 260 and a display component 220), user interaction with the touch screen can be communicated to the user interface controller component 250 as illustrated in FIG. 2. Similarly, where a voice interface (e.g., voice interface is a user interface 260) interacts with the display interface component 210, the interface can effect interaction with selected display components (e.g., 220 and/or 230). Further, user interface components 260 can be communicatively coupled over a wired and/or wireless network (not illustrated) and can be connected both to the mobile computing system (e.g., by way of the display interface component 210 or the user interface controller component 250 directly) and the selected display components directly or daisy chained back to the user interface controller component 250. One of skill in the art will appreciate that modern interface systems (especially those with wireless connectivity such as Bluetooth™) can connect with a plurality of other components in a manner that is germane to the disclosed subject matter and further will appreciate that all such connectivity permutations are considered within the scope of the disclosed subject matter even where it is not feasible to describe every such possible combination of connectivity between the user interface components 260 and the user interface controller component 250.

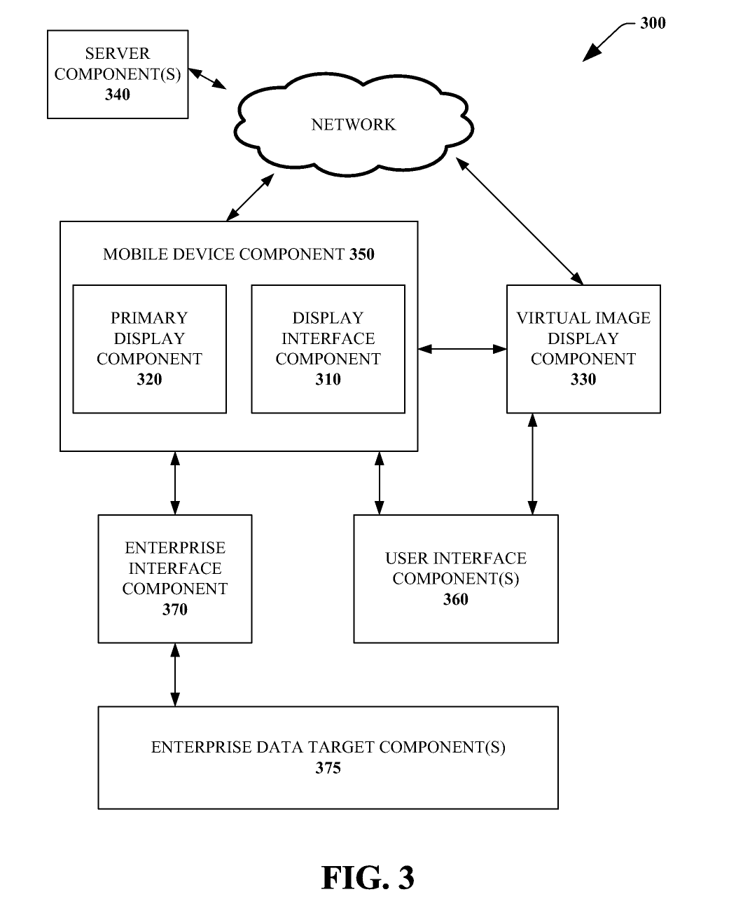

Referring now to FIG. 3, illustrated is a diagram of a system 300 that can facilitate adaptive display of content among a plurality of display components including at least one virtual image display component in accordance with an aspect of the subject matter disclosed herein. System 300, for example, can include a display interface component 310. Display interface component 310 can be the same as, or similar to, display interface component 110 and/or 210. Display interface component 310 can be communicatively coupled to a primary display component 320 and a VID component 330. Primary display component 320 can be the same as, or similar to, primary display component 120 and/or 220 and VID component 330 can be then same as, or similar to, VID component 130 and/or 230.

System 300 can comprise server components 340 communicatively coupled through a wired and/or wireless network to a mobile device component 350. The VID component 330 can further be connected to the wired and/or wireless network (also referred to as the “network”) and thus to the other components of said network. Mobile device component 350 can be a mobile computing device such as a Smartphone, PDA, GPS mapping device, dedicated enterprise device such as a stock ordering device, warehouse pick device, or nursing interface device, among others. In one particular embodiment, a mobile device component 350 can include the primary display component 320 and the display interface component 310 such that the VID component 330 can be an accessory device, such as a head mounted VID device, to the mobile device component 350. As illustrated, mobile device component 350 can access a network for interacting with other devices, sending and receiving information across a network, or other activities familiar to being network connected.

System 300 can further include user interface components 360, which can be the same as, or similar to, user interface devices 260, as herein disclosed. These user interface components 360 can be communicatively coupled to the mobile device component 350, the VID component 330, the network (not illustrated), other components as germane to the disclosed subject matter (not illustrated), or combinations thereof. The user interface components 360 can facilitate interacting with content presented to the user on the plurality of display devices as disclosed herein.

System 300 can further comprise an enterprise interface component 370. The enterprise interface component 370 can be communicatively coupled to the mobile device component 350, the network (not illustrated), other components as germane to the disclosed subject matter (not illustrated), or combinations thereof. The enterprise interface component can facilitate interaction with enterprise data target components 375. An enterprise data target component 375 can be, for example, an RFID tag associated with enterprise data, a bar-code associated with enterprise data, or an external data source related to enterprise data, among other such data target components as will be appreciated by one of skill in the art.

Recalling the grocery clerk example given herein, the ordering device can represent the mobile device component 350 and the bar-code scanning portion of the device can represent the enterprise interface component 370. The bar code scanner can then scan bar codes (e.g., enterprise data target components 375) to access enterprise data (e.g., the grocery chains ordering information data) for display to the user across a plurality of display devices by adaptively routing content for display as herein disclosed.

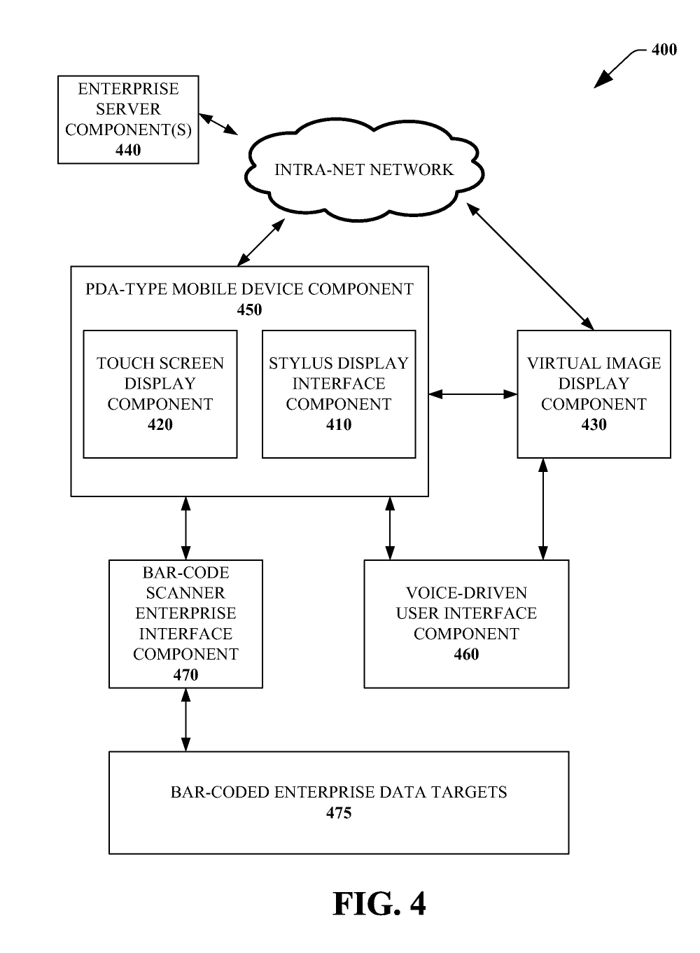

Referring now to FIG. 4, illustrated is a diagram of one possible exemplary system 400 that can facilitate adaptive display of content among a plurality of display components including at least one virtual image display component in accordance with an aspect of the subject matter disclosed herein. System 400 can be the same as, or similar to, system 300 as herein described at a more abstract level. System 400 can include a PDA-type mobile device component 450 (PDA 450) comprising a touch screen display component 420 and a stylus driven display interface component 410. PDA 450 therefore can display content routed to a primary display device on the touch screen display 420. Further, a user can interact with the displayed content by using the stylus trough the interface component 410. PDA 450 can further be communicatively coupled with VID component 430, which for example, can be a head mounted display device.

An additional user interface can be included as a voice-driven interface 460 to interact with content by being communicatively coupled to both the PDA 450 and the VID component 430. This connectivity can be allow voice recognition commands to drive either or both the VID component 430 and/or the PDA 450. The PDA 450 can further comprise a bar-code scanner enterprise interface component 470 to facilitate scanning bar-coded enterprise data targets 475.

The exemplary system 400 can be employed in an exemplary enterprise system wherein a maintenance technician employs PDA 450 and head mounted VID component 430 on service calls within the enterprise. Continuing the example, where the technician responds to a maintenance call on a production line, the technician can determine that a load cell has failed. The technician can scan the bar-code enterprise label of the load cell with PDA 450. PDA 450 can then present the user with primary information including, for example, part name, installation date, and last service date on the touch screen display. Further, icons can be presented to the technician on the primary display indicating a service manual related to the part existing on the enterprise intra-net server and another indicating a link to the load cell manufacturer's website on the enterprise extra-net link to the internet.

The technician can then select the icon for the service manual by touching the touch sensitive display screen with the stylus to indicate a desire to see the service manual. In response the system 400 can access the service manual on the intra-net and provide that content to the PDA 450. The display interface component 410 can determine that the resolution and dimensions of the service manual would best be displayed on the VID component 430. The technician can then view the service manual in the VID component 430 and can interact with the service manual by voice command by way of the voice driven user interface 460.

After reviewing the manual, the technician can determine that the warranty for the part is 90 days and then referring back to the primary display can observe that the load cell is only 60 days old. Based on the determination that the part is still under warranty, the technician can select the icon for the manufacturer's website on the primary display with the stylus. This can cause the PDA 450 to access the internet through the enterprise extra-net and receive content that can again be determined to be best displayed on the VID component 430. The technician can employ the stylus interface to interact with the virtual display to submit the load cell for a warranty repair. The PDA 450 can infer that where a part is being submitted for repair, a substitute part will be needed to bring the process line back into production and in response can receive information relating to parts available on site. It can be determined that this information is suitable for display on the primary display. The technician can the retrieve the part and return the process line to a working state while the original load cell is returned for a warranty repair.

This example illustrates various aspects of the disclosed subject matter, including but not limited to, user interface components facilitating interaction with content displayed on various display components, various types of user interfaces, network access for various components of system 400, access to enterprise data target information based on scanning a bar-code, and selective use of both a primary and supplementary display component for adaptively routing content for display to the user employing both determinations and limited inferences. One of skill in the art will appreciate that this example is very basic and that substantially more complex operations and interactions are readily apparent to one of skill in the art and that all such permutations are within the scope of the disclosed subject matter.

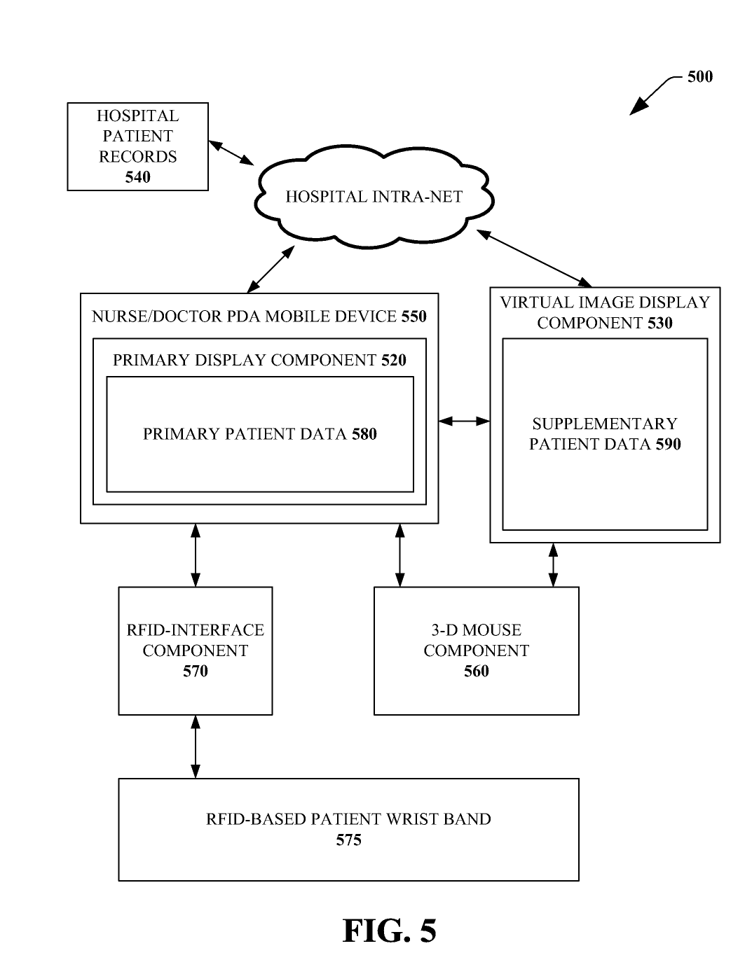

Referring now to FIG. 5, illustrated is a diagram of one possible exemplary system 500 that can facilitate adaptive display of content among a plurality of display components including at least one virtual image display component in accordance with an aspect of the subject matter disclosed herein. System 500 can be similar to system 400 and any differences are easily appreciated in the flow of a descriptive example of system 500 in one possible exemplary usage scenario.

A nurse can use a PDA 550 during daily activities at a hospital for a large HMO. The PDA 550 can employ an RFID interface (as compared to the bar-code interface in system 400). The nurse can be presented with the name and bed number of patients as the nurse walks past the doors of various rooms in the nurse's ward based on RFID scans of patient identifier RFID devices in the patient wristbands give when the patient is admitted. This information can be presented on the primary display of the PDA 550. By presenting this information on the PDA primary display, the nurse is not bombarded with this information in a VID display as the nurse walks down a corridor. This allows the nurse to selectively view the PDA screen by making a conscious decision to look at the PDA screen when the nurse needs this level of primary information content.

The granularity of primary content can be dynamically changed based at least in part on metrics such as the nurse's location in reference to the patient (or more precisely the patient's RFID tag). Thus, as the nurse walks by a room housing one or more patients, the several patients' names therein can be presented on the PDA screen. However, when the nurse enters a particular room (e.g., gets closer to the particular patients) the primary display can present the current vital statistics of the nearest patients and the names and bed numbers of the further patients in the room. As the nurse approaches the bed of a particular patient even more detailed information can be presented on the primary display.

Further, where the nurse selects to view a patient's medical records, this information can be presented to the nurse on the VID component 530 where the level of detail is better presented on a “full sized” virtual display 590. As in system 400 an additional user interaction component can be employed, in system 500, this can be, for example, a 3-D mouse 560. The exemplary mouse can be based on accelerometers in the PDA 550 to track movement of the PDA 550 as mousing actions. This can allow the nurse to interact with the displayed patient's medical chart 590 in the VID component 530 or with primary patient content 580 on the primary display 520.

Again as in system 400, this example (system 500) illustrates various aspects of the disclosed subject matter, including but not limited to, user interface components facilitating interaction with content displayed on various display components, various types of user interfaces, network access for various components of system 500, access to enterprise data target information based on scanning a RFID and proximity sensing, and selective use of both a primary and supplementary display component for adaptively routing content for display to the user employing both determinations and limited inferences such as granularity based on proximity. One of skill in the art will appreciate that this example is very basic and that substantially more complex operations and interactions are readily apparent to one of skill in the art and that all such permutations are within the scope of the disclosed subject matter.

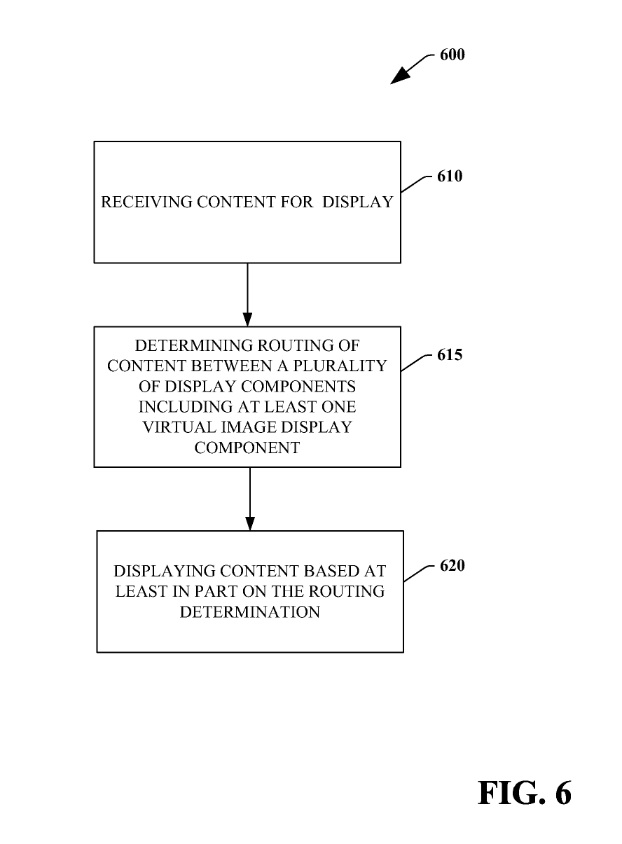

FIGS. 6-9 illustrate methodologies, flow diagrams, and/or timing diagrams in accordance with the disclosed subject matter. It is to be appreciated that the methodologies presented herein can incorporate actions pertaining to a neural network, an expert system, a fuzzy logic system, and/or a data fusion component, or a combination of these, which can generate diagnostics indicative of the optimization of routing content germane to the disclosed methodologies. Further, the prognostic analysis of this data can serve to better optimize dynamic content routing operations, and can be based on real time acquired data or historical data within a methodology or from components related to a methodology herein disclosed, among others. It is to be appreciated that the subject invention can employ highly sophisticated diagnostic and prognostic data gathering, generation and analysis techniques, and such should not be confused with trivial techniques such as simply routing to an alternate display component when a benchmark is reached.

For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 6, illustrated is a methodology 600 that can facilitate adaptive display of content among a plurality of display components including at least one virtual image display component in accordance with an aspect of the subject matter disclosed herein. Conventionally, methodologies for displaying content on mobile computing devices simply entailed displaying content of the attached display device. As previously stated, the use of virtual image display devices has allowed substitution of the VID device for the conventional display device in conventional methodologies. Thus, a conventional methodology is generally display independent where the display is treated as a single component (e.g., where the actual techniques of displaying images in ignored for the moment).

In contrast, methodology 600 facilitates adaptive display of content among a plurality of display components including at least one virtual image display component. At 610 content for display to a user can be received. For example, where a mobile computing device is employed in an interstate trucking operation, a driver's mobile computing system can receive weather information. At 615 routing of the content among a plurality of display components can be determined. Continuing the example, it can be determined to present a selectable list of imminent weather disturbances to the trucker on an in dash primary LCD display. Further it can be determined that where the user selects a link the more detailed weather map and conditions will be displayed in a heads up display (HUD) on the truckers windshield having a virtual image size that is much larger and more detailed than the in dash LCD. At 620, the content can be displayed based on the determination at 615. In the example, an upcoming snow storm can be listed on the LCD for a pass the trucker is approaching. When the trucker selects the snow storm link on the LCD, the HUD (e.g., a HUD can be a VID device) can display a more detailed weather map on the truckers windscreen to provide additional information to the trucker.

In addition to this basic functionality, additional inferences and determinations can be made regarding routing of content. For example, where the trucker is above a predetermined speed, displaying weather information on the HUD can be prohibited. As another example, speed limit data can be automatically presented on the HUD based on the GPS location of the truck to keep the trucker informed of the local ordinances. As another example, where biometric sensors detect that the trucker is sleepy, it can be inferred that lodging information should be displayed on the primary display for a period of time and then escalated to the HUD display. As disclosed herein, numerous metrics can be combined in the formation of determinations or inferences relating to the adaptive routing of content among various display devices. These methods differ substantially from traditional methods in that they are not merely substituting one display modality for another but rather are actively routing display content to selective displays based on a predetermination or an inference relating to the content. At this point, methodology 600 can end.

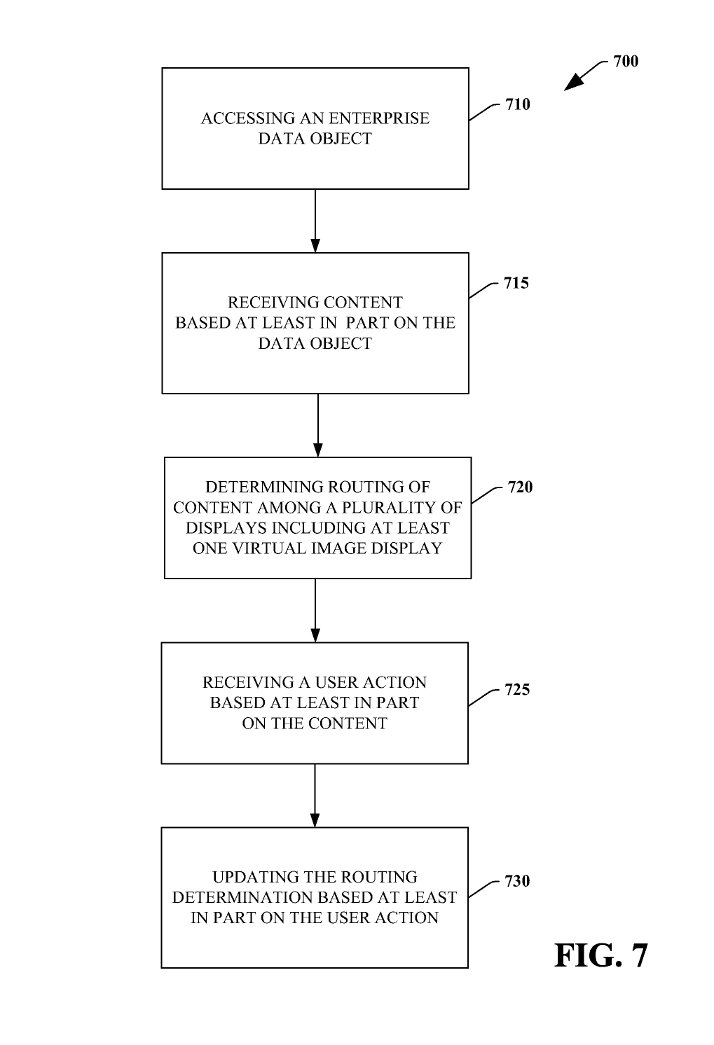

Referring now to FIG. 7, illustrated is a methodology 700 that can facilitate adaptive display of content among a plurality of display components including at least one virtual image display component in accordance with an aspect of the subject matter disclosed herein. At 710, methodology 700 can access an enterprise data object. As disclosed herein, numerous modalities exist for accessing data related to enterprise objects (e.g., bar-code, RFID, visual identification, biometrics, physical sensors . . . ) and such data can be employed in forming content for display to a user based at least in part on the enterprise object data accessed.

At 715, data related to the accessed data object can be received. At 720, routing of content can be determined. The received data can at least in part contribute to the content to be routed among the various display devices. Where this content foreseeably comprises a wide variety of data types, the type of data can form on e possible metric for determining routing. However as disclosed herein, numerous other metrics can be employed in determining how to route data and all such permutations are considered within the scope of the disclosed subject matter.

At 725, a user action based at least in part on the content can be received. Where the user interacts with the routed content, the method can receive this user input to adapt the routing. As disclosed herein, a user interface can be any of a large number of modalities (e.g., voice control, mousing, keyboards, touch screens, eye tracking . . . ) and all such modalities are considered within the scope of the disclosed subject matter. At 730, the routing of content can be updated based at least in part on the user interaction. This provides for dynamic routing of information based on changing conditions and/or user input as disclosed herein. At this point, methodology 700 can end.

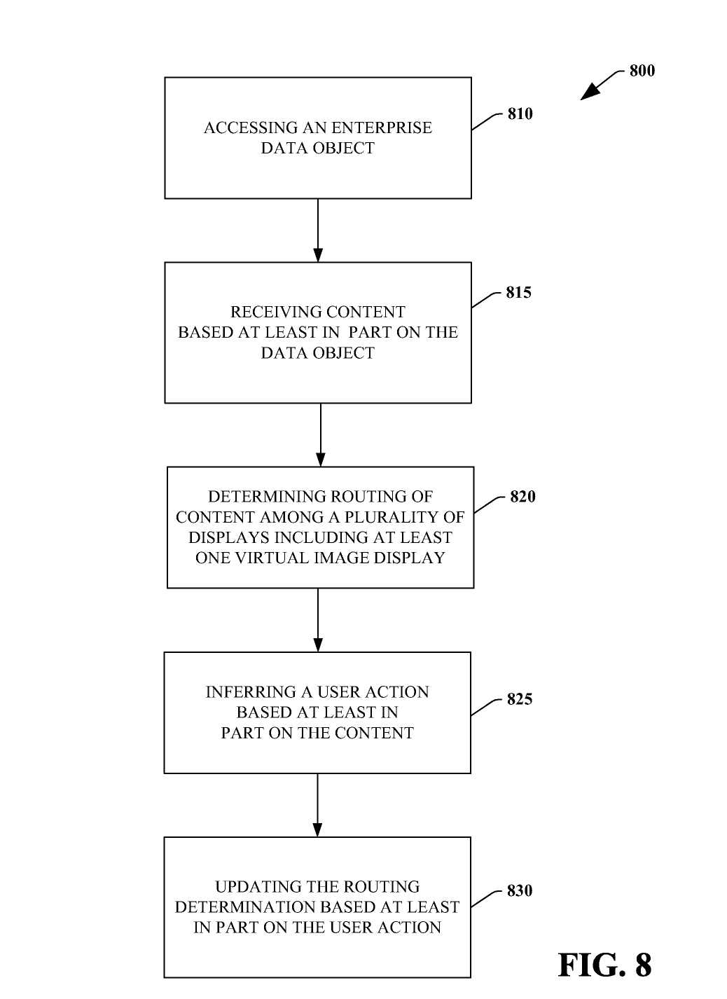

Referring now to FIG. 8, illustrated is a methodology 800 that can facilitate adaptive display of content among a plurality of display components including at least one virtual image display component in accordance with an aspect of the subject matter disclosed herein. Methodology 800 can be similar to methodology 700. At 810, methodology 800 can access an enterprise data object. As disclosed herein, numerous modalities exist for accessing data related to enterprise objects (e.g., bar-code, RFID, visual identification, biometrics, physical sensors . . . ) and such data can be employed in forming content for display to a user based at least in part on the enterprise object data accessed.

At 815, data related to the accessed data object can be received. At 820, routing of content can be determined. The received data can at least in part contribute to the content to be routed among the various display devices. Where this content foreseeably comprises a wide variety of data types, the type of data can form one possible metric for determining routing. However as disclosed herein, numerous other metrics can be employed in determining how to route data and all such permutations are considered within the scope of the disclosed subject matter.

At 825, a user action, based at least in part on the content, can be inferred. Unlike methodology 700, this methodology incorporates inferring user actions based, for example, on a user's historic patterns of interaction, a user's context, a goal of the user, or the like. As disclosed herein, a user interface can be any of a large number of modalities (e.g., voice control, mousing, keyboards, touch screens, eye tracking . . . ) and all such modalities are considered within the scope of the disclosed subject matter. Thus, it can further be appreciated that for each of these modalities, inferences can be formed and all such combinations of inferences across the various modalities are also considered within the scope of the disclosed subject matter. At 830, the routing of content can be updated based at least in part on the inferred user actions. This provides for dynamic routing of information based on changing conditions and/or a user's anticipated (e.g., inferred) actions as related to the currently routed content. At this point, methodology 800 can end.

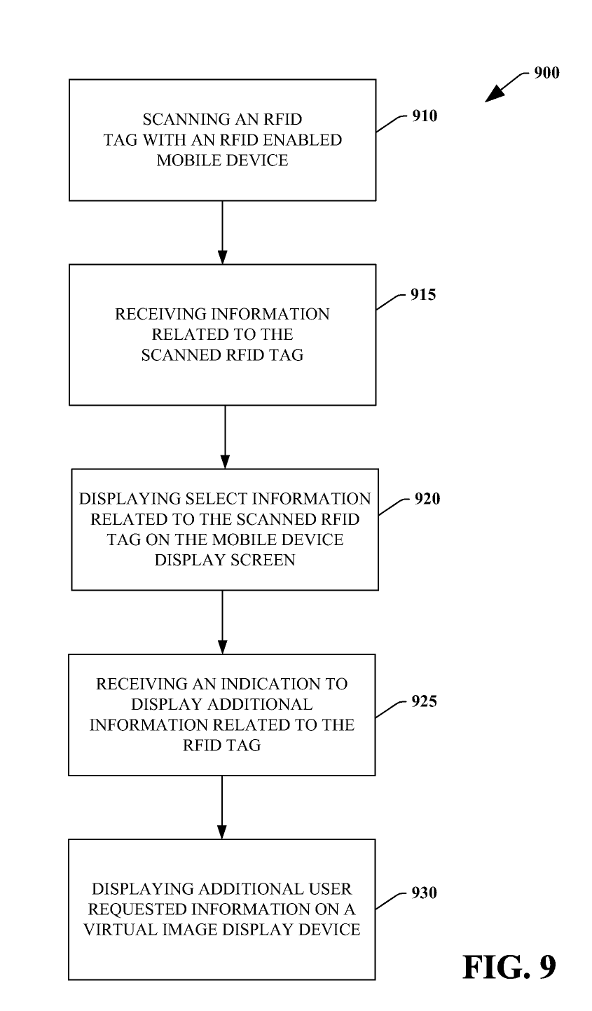

Referring now to FIG. 9, illustrated is a possible exemplary methodology 900 that can facilitate adaptive display of content among a plurality of display components including at least one virtual image display component in accordance with an aspect of the subject matter disclosed herein. Methodology 900 can be similar to methodologies 700 and 800.

At 910, methodology 900 can access an enterprise data object based on scanning a RFID tag. At 915, data related to the accessed RFID data object can be received. Routing of content can be determined such that, for example at 920 select content related to the scanned RFID object is displayed on a primary display of a mobile device. At 925, a user interaction can be received (or inferred). This interaction can (as in 925) indicate that additional content is desired. At 930, the routing of content can be updated based at least in part on the user actions. Thus at 930, the requested additional content can be displayed on VID device. Similarly, the content routed to the primary display can be dynamically s adjusted. At this point, methodology 900 can end.

71 As will be appreciated by one of skill in the art, methodology 900 is a highly simplified example of how this particular methodology might work for purposes of enablement. One of skill in the art will further appreciate the additional actions or repetition of actions within methodology 900 would create a much richer dynamic routing of content methodology in accordance with the other disclosure herein presented and that any such methodology is considered within the scope of the disclosed subject matter.

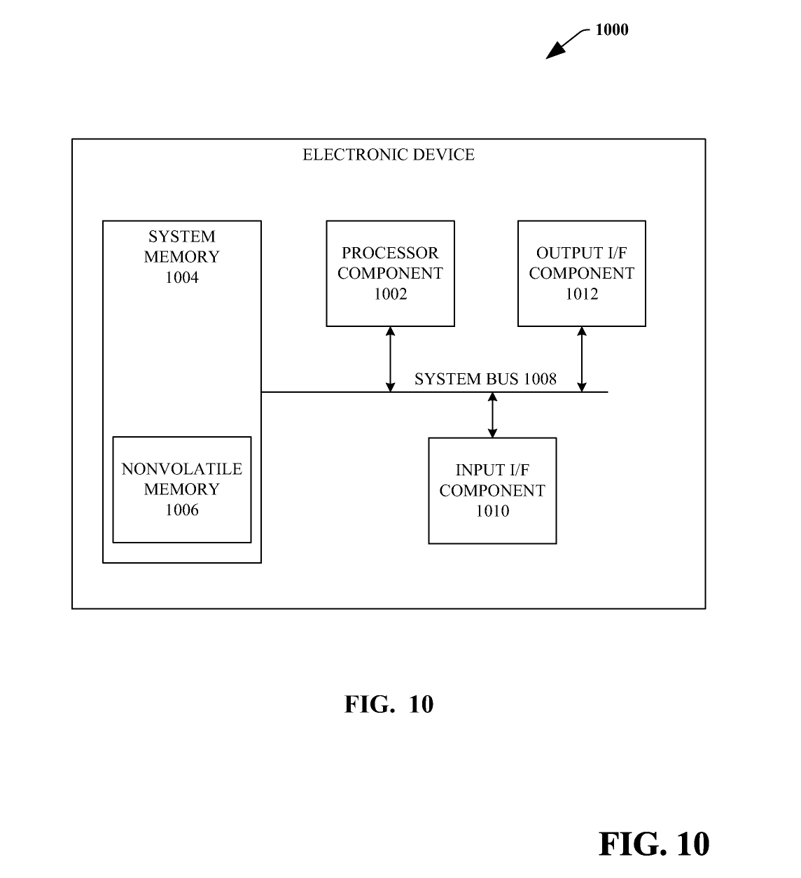

Referring to FIG. 10, illustrated is a block diagram of an exemplary, non-limiting electronic device 1000 that can include adaptive display of content among a plurality of display components including at least one virtual image display component in accordance with one aspect of the disclosed subject matter. The electronic device 1000 can include, but is not limited to, a computer, a laptop computer, network equipment (e.g. routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system (e.g., global position satellite (GPS) system), secure memory devices with computational capabilities, devices with tamper-resistant chips, an electronic device associated with an industrial control system, an embedded computer in a machine (e.g., an airplane, a copier, a motor vehicle, a microwave oven), and the like.

Components of the electronic device 1000 can include, but are not limited to, a processor component 1002, a system memory 1004 (with nonvolatile memory 1006), and a system bus 1008 that can couple various system components including the system memory 1004 to the processor component 1002. The system bus 1008 can be any of various types of bus structures including a memory bus or memory controller, a peripheral bus, or a local bus using any of a variety of bus architectures.

Electronic device 1000 can typically include a variety of computer readable media. Computer readable media can be any available media that can be accessed by the electronic device 1000. By way of example, and not limitation, computer readable media can comprise computer storage media and communication media. Computer storage media can include volatile, non-volatile, removable, and non-removable media that can be implemented in any method or technology for storage of information, such as computer readable instructions, data structures, program modules or other data. Computer storage media includes, but is not limited to, RAM, ROM, EEPROM, nonvolatile memory 1006 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1000. Communication media typically can embody computer readable instructions, data structures, program modules or other data in a modulated data signal such as a carrier wave or other transport mechanism and includes any information delivery media.

The system memory 1004 can include computer storage media in the form of volatile and/or nonvolatile memory 1006. A basic input/output system (BIOS), containing the basic routines that help to transfer information between elements within electronic device 1000, such as during start-up, can be stored in memory 1004. Memory 1004 can typically contain data and/or program modules that can be immediately accessible to and/or presently be operated on by processor component 1002. By way of example, and not limitation, system memory 1004 can also include an operating system, application programs, other program modules, and program data.

The nonvolatile memory 1006 can be removable or non-removable. For example, the nonvolatile memory 1006 can be in the form of a removable memory card or a USB flash drive. In accordance with one aspect, the nonvolatile memory 1006 can include flash memory (e.g., single-bit flash memory, multi-bit flash memory), ROM, PROM, EPROM, EEPROM, or NVRAM (e.g., FeRAM), or a combination thereof, for example. Further, the flash memory can be comprised of NOR flash memory and/or NAND flash memory.

A user can enter commands and information into the electronic device 1000 through input devices (not shown) such as a keypad, microphone, tablet or touch screen although other input devices can also be utilized (e.g., the information display with optical data capture can be employed as an input device such as, for example, a virtual keyboard, etc.). These and other input devices can be connected to the processor component 1002 through input interface component 1012 that can be connected to the system bus 1008. Other interface and bus structures, such as a parallel port, game port or a universal serial bus (USB) can also be utilized. A graphics subsystem (not shown) can also be connected to the system bus 1008. A display device (not shown) can be also connected to the system bus 1008 via an interface, such as output interface component 1012, which can in turn communicate with video memory. In addition to a display, the electronic device 1000 can also include other peripheral output devices such as speakers (not shown), which can be connected through output interface component 1012.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g., in execution), and/or firmware. For example, a component can be, but is not limited to being, a process running on a processor, a processor, a circuit, a collection of circuits, an object, an executable, a thread of execution, a program, and/or a computer. By way of illustration, both an application running on a server and the server can be a component. One or more components can reside within a process and a component can be localized on one computer and/or distributed between two or more computers.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

Some portions of the detailed description may have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

### Artificial Intelligence

Artificial intelligence based systems (e.g., explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

For example, an artificial intelligence based system can evaluate current or historical evidence associated with historical content routing and based in part in such evaluation, can render an inference, based in part on probability, regarding, for instance, the probability of similar content routing, among other such examples of probabilistic determinations. One of skill in the art will appreciate that intelligent and/or inferential systems can facilitate further optimization of the disclosed subject matter and such inferences can be based on a large plurality of data and variables all of with are considered within the scope of the subject innovation.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates adaptive display of content among a plurality of display components comprising:
a display interface component that at least in part determines routing of content among a plurality of display components;
a primary display component; and
a virtual image display component.

2. The system of claim 1, further comprising additional display components, additional virtual image display components, or combinations thereof.

3. The system of claim 1, wherein content displayed on a first display component is exclusive of content displayed on a virtual image display component.

4. The system of claim 1, wherein the display interface component further comprises a user interface controller component facilitating user interface interactions with content, selectively, among the plurality of display components, virtual image display components, or combinations thereof.

5. The system of claim 1, further comprising a wired network, a wireless network, or some combination thereof, facilitating communication between system components.

6. The system of claim 5, wherein the various networks facilitate access to an intra-net, an extra-net, the internet, server components, or any combination thereof.

7. The system of claim 1, further comprising an interface facilitating accessing data targets.

8. The system of claim 7, wherein the interface comprises a bar-code scanner modality, an RFID interface modality, a biometric interface modality, a visual recognition modality, a proximity sensor modality, a location sensor modality, a physical characteristic sensor modality, or a combination thereof.

9. The system of claim 7, wherein the data targets are correlated to enterprise data sources to facilitate sourcing content.

10. The system of claim 1, wherein the visual image display component is a head-mounted virtual image display component, the primary display component is an LCD display, or some combination thereof.

11. The system of claim 1, further comprising a user interface component that facilitates interaction with content directly through the virtual image display component, directly through the primary display component, or some combination thereof.

12. The system of claim 1, routing content based at least in part on enterprise level data among at least a display component or virtual image display component owned by the enterprise of the data.

13. The system of claim 1, embodied in a hand held mobile computing device and a head mounted virtual image display device.

14. The system of claim 1, at least in part embodied in a hand held mobile computing device, a wearable mobile device, an implanted mobile computing device, or combinations thereof.

15. The system of claim 1, employed in an environment including at least one of warehousing, distribution, shipping, receiving, freight movement, package delivery, sales, retail presentation, customer service, information sharing, or any combination thereof.

16. The system of claim 1, employed in a healthcare environment, nursing home environment, pharmaceutical supply environment, hospital environment, or combination thereof.

17. An electronic device comprising:
a first display component that is not a virtual image display component;
a second display component that is a virtual image display component; and
a display interface component facilitating routing of content for display among at least the first and second display components such that displayed content is exclusive as between the first and second display components.

18. A method that facilitates adaptive display of content among a plurality of display components comprising:
receiving content for display;
determining routing of content among a plurality of display components including at least on virtual image display component; and
displaying content based at least in part on the routing determination.

19. The method of claim 18, further comprising:
receiving a user interaction based at least in part on the content; and
dynamically adjusting the routing determination based at least in part on the user interaction.

20. The method of claim 18, further comprising receiving content based at least in part on accessing data related to an enterprise data object.
